(19) United States
(12) Patent Application Publication
(10) Pub. No.: US 2007/0276978 A1
(43) Pub. Date: Nov. 29, 2007

(54) Universal Serial Bus (USB) memory system and control method thereof

(75) Inventors: Chin-Ling Wang, Hsinchu (TW); Khein-Seng Pua, Hsinchu (TW); Tzung-Horng Kuang, Hsinchu (TW)

Correspondence Address: BACON & THOMAS, PLLC, 625 SLATERS LANE, FOURTH FLOOR, ALEXANDRIA, VA, 22314, US

(73) Assignee: Phison Electronics Corp., Hsinchu (TW)

(21) Appl. No.: 11/440,063

(22) Filed: May 25, 2006

(51) Int. Cl. G06F 13/14

(52) U.S. Cl. 710/305

(57) ABSTRACT

A universal serial bus (USB) memory system and a control method thereof are disclosed. The USB memory system includes a microprocessor, a storage unit in communication with the microprocessor, an interface unit in communication with the microprocessor, an audio device in communication with the microprocessor, and a sound output device in communication with the audio device. Moreover, the control method includes steps of a) automatically executing a program of a host system while the USB memory system is connected with the host system via the interface unit; b) selecting one of a MIDI and a chord signal as an audio signal via the program; c) transmitting the audio signal to the audio device; d) decoding the audio signal by the audio device and transmitting a resultant decoded sound signal to the sound output device; and e) outputting the decoded sound signal via the sound output device.

### FIELD OF THE INVENTION

The present invention relates to a Universal Serial Bus (USB) memory system, and more particularly, to a Universal Serial Bus (USB) memory system with audio indicator and a control method thereof.

### BACKGROUND OF THE INVENTION

The capabilities of computers are maximized via utilizing a variety of external peripheral devices that are connected to the computer, wherein a lot of peripherals might be involved. Meanwhile, a Universal Serial Bus (USB) interface standard was jointly developed in response to computers becoming more modular. The USB standard defines a high-speed serial data interface between a computer and add-on devices, such as keyboards, printers, scanners and secondary storage devices, including floppy disk drives, hard disk drives, and solid-state secondary storage drives. In computers that have USB compliant ports, such devices can be added or removed while the computer is powered up and running.

Furthermore, in the computer arts there continues to be motivation for increased density and ease-of-use in mass storage devices. A solid state device known now in the art as a memory drive was relatively recently introduced advancing the standard for both density and ease-of-use, and such hot-plug drives are made by several manufacturers. A common feature of thumb memory drives as known in the art is a male USB connector, and functionality to hot-plug and remove, that is, without turning off the computer to which the drive is connected and disconnected. Another common feature is a plastic protective cover for the male USB connector.

Such USB memory device does not require a specialized reader but can be plugged into a USB connector on a personal computer (PC) or other hosting device. These USB memory devices can be used in place of floppy disks and are known as USB key drives, USB thumb drives, and a variety of other names. These USB memory devices can have a capacity of more than ten floppy disks in an area not much larger than a large postage stamp. In practice, a USB memory device usually has an indicator LED light for indicating the signal-transmitting of the USB memory device. When the USB memory device is plugged into a USB host, or performed for transmitting and receiving, the indicator LED light of the USB memory device will be ignited to indicate the current status of the USB memory device. However, some USB connectors of PC or other hosting device are not located visibly. When a USB memory device is plugged into the USB connector, wherein the indicator LED light of the USB memory device is hidden and can't be seen by the user directly. If the hidden USB memory device is not running or breakdown, the user can't be informed by the indicator LED light of the USB memory device, because the user can't see the indicating signal of the indicator LED light directly. Similarly, some USB memory device further introduces several indicator LED lights for extra application. For example, a red LED and a green LED are introduced for indicating RF signal or indicating valid data being received. Certainly, if the USB memory device is plugged into the hidden USB connector of PC or other hosting device and the user can't see the indicator LED lights directly, thereby the USB memory device being unable to provide indicating functions effectively.

Although such multi-application USB memory devices with indicator LED lights are technically feasible, in practice they are very difficult to implement. As it is not possible for users to tell if it is the trouble of the USB memory device, or some other factors, once the trouble occurs, the USB memory device could be performed conveniently. When the conventional USB memory device is used together with hidden USB connectors, and it is not easy to know if the USB memory device is at normal operation status by means of checking the indicator LED light. Hence, it needs to provide a Universal Serial Bus (USB) memory system, which provides an extra audio signal in order to know if it is the trouble of the USB memory device cable, simplifies the performing process, and can rectify those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide a Universal Serial Bus (USB) memory system, which introduces an extra audio signal, instead of a LED indicator in order to know if it is the trouble of the USB memory device cable, simplifies the performing process of the USB memory device.

In accordance with an aspect of the present invention, the USB memory system includes a microprocessor; a storage unit in communication with the microprocessor; an interface unit in communication with the microprocessor for connecting the USB memory system to a host system; and an audio device in communication with the microprocessor for producing an audio signal in response to an instruction of the microprocessor, wherein the audio device is powered by the host system.

Preferably, the storage unit comprises a flash memory, an Electrically Erasable Programmable Read Only Memory (EEPROM), a hard disk drive (HDD), and a memory card.

Certainly, the interface unit can be one selected from a group consisting of a serial peripheral interface (SPI), a host interface, a serial interface, a parallel interface, and an IIC interface.

Preferably, the interface unit comprises IDE, ATA, SATA, and PCI-Express.

Certainly, the host system can be a personal computer.

Preferably, the audio device is a MIDI output device.

Preferably, the audio device further includes a sound output device.

Certainly, the sound output device can be a sound speaker.

Preferably, the host system further includes a program for selecting one of a MIDI and a chord signal as the audio signal to be outputted in response to the instruction of the microprocessor.

Preferably, the MIDI and the chord signal are downloaded from a personal computer and decoded by the audio device.

Preferably, the USB memory system further includes an external triggering unit in communication with the microprocessor for receiving a triggering signal to control the audio device.

Preferably, the external triggering unit is one of a push button and an infrared ray receiver.

It is another object of the present invention to provide a control method of a Universal Serial Bus (USB) memory system, wherein an extra audio signal is introduces, instead of introducing a LED indicator signal, in order to know if it is the trouble of the USB memory device cable, simplifies the performing process of the USB memory device.

In accordance with the aspect of the present invention, the control method of a USB memory system including a microprocessor, a storage unit in communication with the microprocessor, an interface unit in communication with the microprocessor, an audio device in communication with the microprocessor, and a sound output device in communication with the audio device, includes steps of: a) automatically executing a program of a host system while the USB memory system is connected with the host system via the interface unit; b) selecting one of a MIDI and a chord signal as an audio signal via the program; c) transmitting the audio signal from the host system to the microprocessor; d) transmitting the audio signal from the microprocessor to the audio device; e) decoding the audio signal by the audio device and transmitting a resultant decoded sound signal to the sound output device; and f) outputting the decoded sound signal via the sound output device.

Certainly, the host system can be a personal computer.

Preferably, the audio device is a MIDI output device.

Preferably, the sound output device is a sound speaker.

In accordance with the aspect of the present invention, the control method of a USB memory system including a microprocessor, a storage unit in communication with the microprocessor, an interface unit in communication with the microprocessor, an external triggering unit in communication with the microprocessor, an audio device in communication with the microprocessor, and a sound output device in communication with the audio device, includes steps of: a) connecting USB memory system with the host system via the interface unit; b) determining whether an audio signal will be outputted in response to a triggering signal from the external triggering unit; c) selecting one of a MIDI and a chord signal as the audio signal to be outputted; d) transmitting the audio signal to the audio device; e) decoding the audio signal by the audio device and transmitting a resultant decoded sound signal to the sound output device; and f) outputting the decoded sound signal via the sound output device.

Preferably, the external triggering unit is one of a push button and an infrared ray receiver.

Preferably, the audio signal is stored in the storage unit and transmitted from the storage unit to the audio device through the microprocessor.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 illustrates a preferred embodiment of a Universal Serial Bus (USB) memory system with an extra audio signal according to the present invention.

FIG. 2 illustrates a preferred embodiment of a control method of the Universal Serial Bus (USB) memory system with an extra audio signal according to the present invention.

FIG. 3 illustrates another preferred embodiment of a Universal Serial Bus (USB) memory system with an extra audio signal according to the present invention.

FIG. 4 illustrates a second embodiment of a control method of the Universal Serial Bus (USB) memory system with an extra audio signal according to the present invention.

FIG. 5 illustrates a third embodiment of a control method of the Universal Serial Bus (USB) memory system with an extra audio signal according to the present invention.

### DETAILED DESCRIPTION OF THE PREFERRED EMBODIMENT

The present invention discloses a Universal Serial Bus (USB) memory system with audio signal and a control method thereof, and the objects and advantages of the present invention will become more readily apparent to those ordinarily skilled in the art after reviewing the following detailed description. The present invention needs not be limited to the following embodiment.

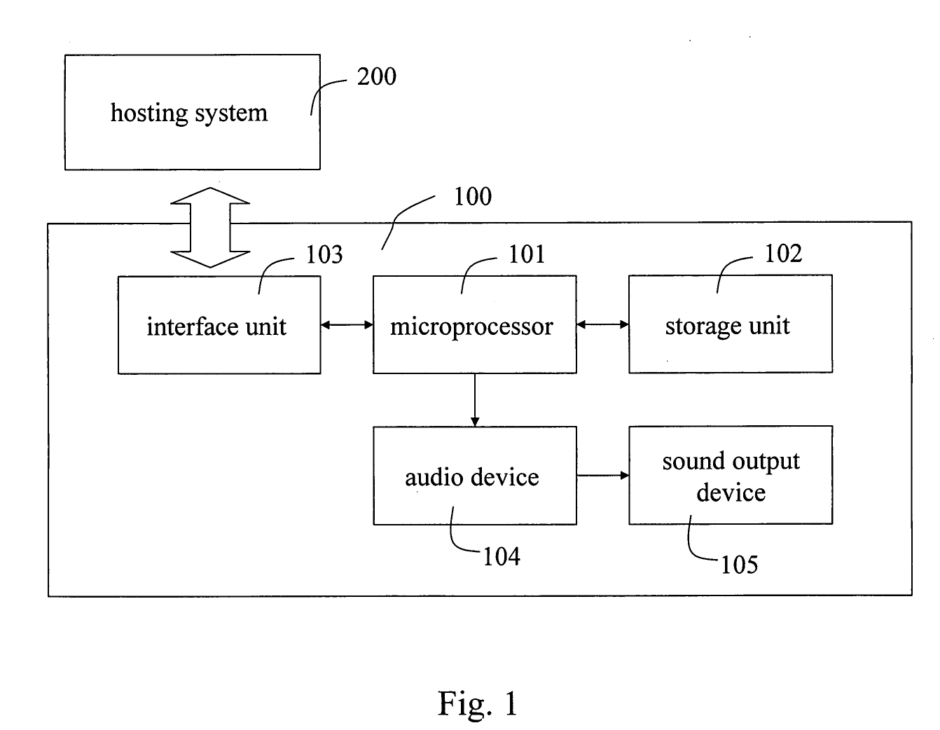

Please refer to FIG. 1. It illustrates a Universal Serial Bus (USB) memory system with an extra audio signal according to the present invention. As shown in FIG. 1, the USB memory system 100 includes a microprocessor 101; a storage unit 102 in communication with the microprocessor 101; an interface unit 103 in communication with the microprocessor 101 for connecting the USB memory system 100 to a host system 200; and an audio device 104 in communication with the microprocessor 101 for producing an audio signal in response to an instruction of the microprocessor 101.

In practice, the storage unit 102 could be a flash memory, an Electrically Erasable Programmable Read Only Memory (EEPROM), a hard disk drive (HDD), or a memory card, wherein the storage unit 102 stores a MIDI or chord signal of audio signals, or storing normal data merely. Certainly, the stored data of the storage unit 102 could be loaded or unloaded through the microprocessor 101. Furthermore, the microprocessor 101 could link with the host system 200 through the interface unit 103, wherein the interface unit 103 could be one selected from a group consisting of a serial peripheral interface (SPI), a host interface, a serial interface, a parallel interface, and an IIC interface. Certainly, the interface unit 103 also can be one selected from a group consisting of IDE, ATA, SATA, and PCI-Express. Therefore, the host system 200 can be a personal computer or other compact computers. More particularly, the present discloses the audio device 104 for producing an audio signal in response to an instruction of the microprocessor 101, wherein the audio device 104 can be a MIDI output device. Certainly, the audio device 104 further connects with a sound output device, such as a sound speaker, to output sounds of the audio signal, thereby informing the user of the current status of the USB memory device or the trouble of the USB memory device. Preferably, the host system 200 further includes a program (not shown) for selecting one of a MIDI and a chord signal as the audio signal to be outputted in response to the instruction of the microprocessor 101, wherein the MIDI and the chord signal are stored in the storage unit 102 and can be downloaded from the host system 200 and then decoded by the audio device 104.

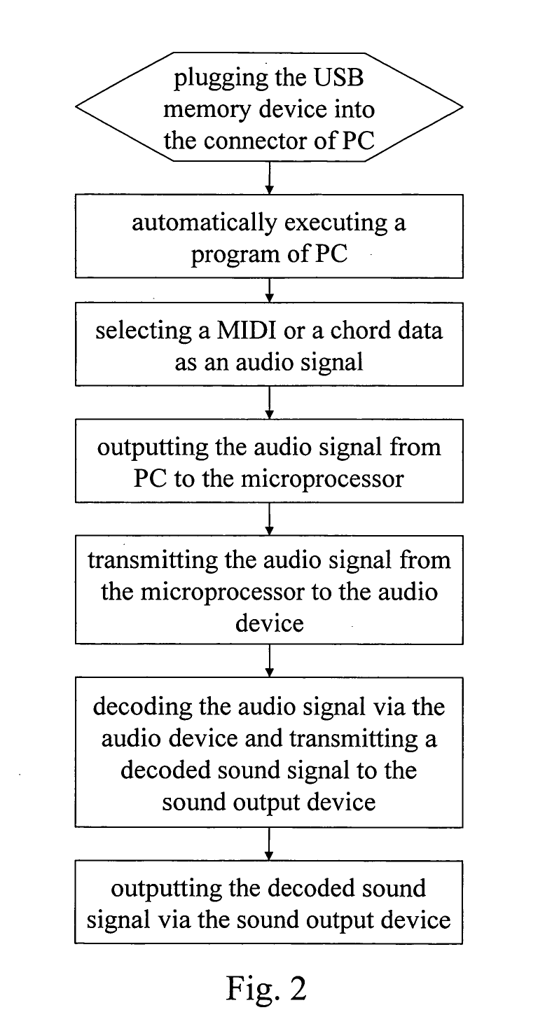

Please refer to FIG. 2. It further illustrates a flow chart of a control method of the Universal Serial Bus (USB) memory system with an extra audio signal according to the present invention. Meanwhile, the USB memory system is disclosed as FIG. 1, wherein the USB memory system 100 includes a microprocessor 101; a storage unit 102 in communication with the microprocessor 101; an interface unit 103 in communication with the microprocessor 101 for connecting the USB memory system 100 to a host system 200; an audio device 104 in communication with the microprocessor 101 for producing an audio signal in response to an instruction of the microprocessor 101, and a sound output device 105 in communication with the audio device 104. Accordingly, the control method of the USB memory system includes steps of a) automatically executing a program of a host system 200 while the USB memory system 100 is connected with the host system 200 via the interface unit 103; b) selecting one of a MIDI and a chord signal from the storage unit 102 as an audio signal via the program; c) transmitting the audio signal from the microprocessor 101 to the audio device 104; e) decoding the audio signal by the audio device 104 and transmitting a resultant decoded sound signal to the sound output device 105; and f) outputting the decoded sound signal via the sound output device 105 in response to a control signal of the microprocessor 101. Meanwhile, the control signal is in response to the current status of the USB memory device 100 or the trouble of the USB memory device 100. For example, if the USB memory device 100 includes a password for operation, the control signal is response to the comparing result of the input value and the correct password. The microprocessor 101 produces the control signal according to the comparing result, and then the sound output device 105 outputs sounds for informing the user about the comparing result of password.

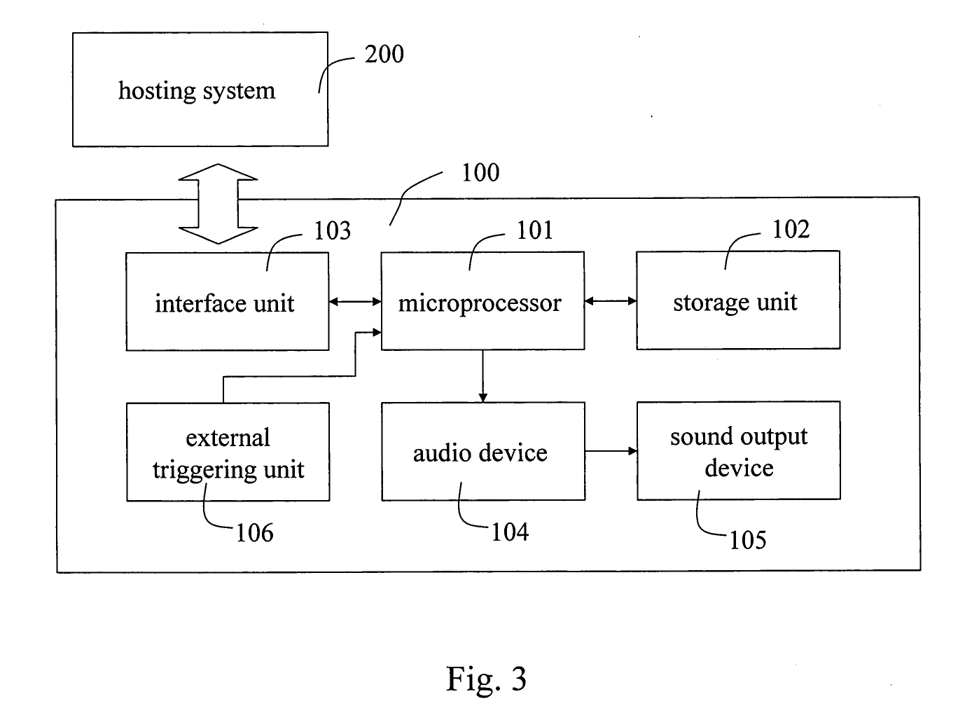

Please refer to FIG. 3. It illustrates a Universal Serial Bus (USB) memory system with an extra audio signal according to the present invention. As shown in FIG. 3, the USB memory system 100 includes a microprocessor 101; a storage unit 102 in communication with the microprocessor 101; an interface unit 103 in communication with the microprocessor 101 for connecting the USB memory system 100 to a host system 200, an audio device 104 in communication with the microprocessor 101, an external triggering unit 106 in communication with the microprocessor 101 for receiving a triggering signal to control the audio device 104, and a sound output device 105 in communication with the audio device 104.

In practice, the storage unit 102 could be a flash memory, an Electrically Erasable Programmable Read Only Memory (EEPROM), a hard disk drive (HDD), or a memory card, wherein the storage unit 102 stores a MIDI or chord signal of audio signals, or storing normal data merely. Certainly, the stored data of the storage unit 102 could be loaded or unloaded through the microprocessor 101. Furthermore, the microprocessor 101 could link with the host system 200 through the interface unit 103, wherein the interface unit 103 could be one selected from a group consisting of a serial peripheral interface (SPI), a host interface, a serial interface, a parallel interface, and an IIC interface. Certainly, the interface unit 103 also can be one selected from a group consisting of IDE, ATA, SATA, and PCI-Express. Therefore, the host system 200 can be a personal computer or other compact computers. More particularly, the present discloses the audio device 104 for producing an audio signal in response to an instruction of the microprocessor 101, wherein the audio device 104 can be a MIDI output device. Certainly, the audio device 104 further connects with a sound output device, such as a sound speaker, to output sounds of the audio signal, thereby informing the user of the current status of the USB memory device or the trouble of the USB memory device. Preferably, the host system 200 further includes a program (not shown) for selecting one of a MIDI and a chord signal as the audio signal to be outputted in response to the instruction of the microprocessor 101, wherein the MIDI and the chord signal are stored in the storage unit 102 and can be downloaded from the host system 200 and then decoded by the audio device 104. Preferably, the external triggering unit could be a push button or an infrared ray receiver.

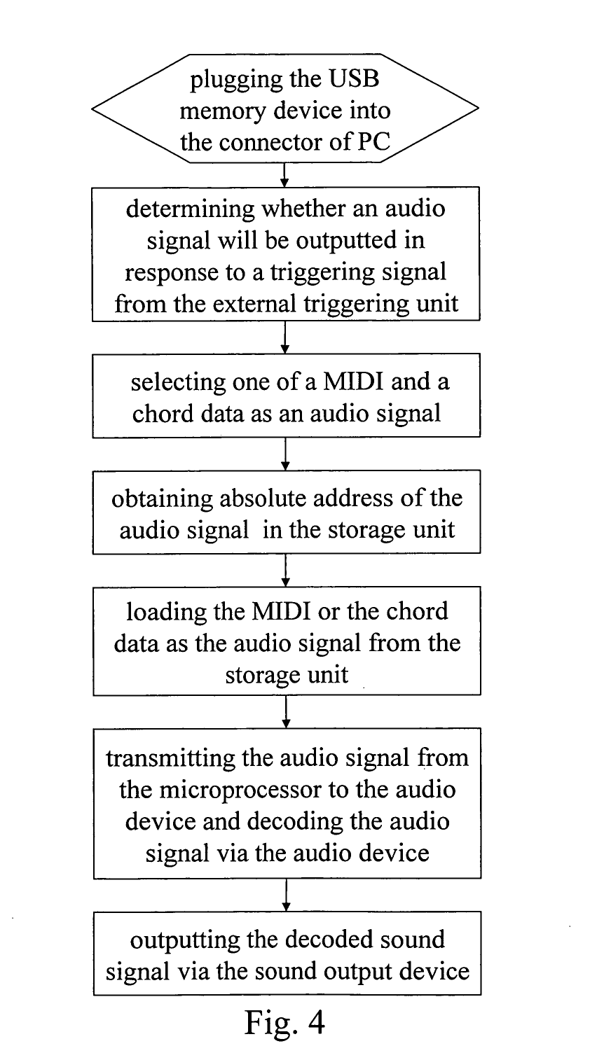

Please refer to FIG. 4. It further illustrates another preferred embodiment of a control method of the Universal Serial Bus (USB) memory system with an extra audio signal according to the present invention. Meanwhile, the USB memory system is disclosed as FIG. 3, wherein the USB memory system 100 includes a microprocessor 101; a storage unit 102 in communication with the microprocessor 101; an interface unit 103 in communication with the microprocessor 101 for connecting the USB memory system 100 to a host system 200, an audio device 104 in communication with the microprocessor 101, an external triggering unit 106 in communication with the microprocessor 101 for receiving a triggering signal to control the audio device 104, and a sound output device 105 in communication with the audio device 104. Accordingly, the control method of the USB memory system includes steps of a) connecting USB memory system 100 with the host system 200 via the interface unit 103; b) determining whether an audio signal will be outputted in response to a triggering signal from the external triggering unit 106; c) selecting one of a MIDI and a chord signal as the audio signal to be outputted, wherein the absolute address of the MIDI and the chord signal stored in the storage unit 102 is calculated and obtained; d) transmitting the audio signal to the audio device 104 from the storage unit 102 via the microprocessor 101; e) decoding the audio signal by the audio device 104 and transmitting a resultant decoded sound signal to the sound output device 105; and f) outputting the decoded sound signal via the sound output device 105 in response to a control signal of the microprocessor 101 for informing about the current status of the USB memory device 100 or the trouble of the USB memory device 100. Meanwhile, the control signal is in response to the current status of the USB memory device 100 or the trouble of the USB memory device 100. When the user starts the external triggering unit 106 and the triggering signal will be transmitted to the microprocessor 101, and then a control signal of the microprocessor 101 is transmitted to the audio device 104 and the sound output device 105 outputs sounds to inform the user. Certainly, the control signal can also be transmitted while the USB memory device 100 is linked with the host system 200, such as a personal computer, and then a control signal of the microprocessor 101 is transmitted to the audio device 104 and the sound output device 105 outputs sounds to inform the user. Simply speaking, when a USB memory device of the present invention is plugged into a PC, a program will be executed automatically to download a MIDI, a speech, a tone sound data and then the sounds are outputted via the USB memory device.

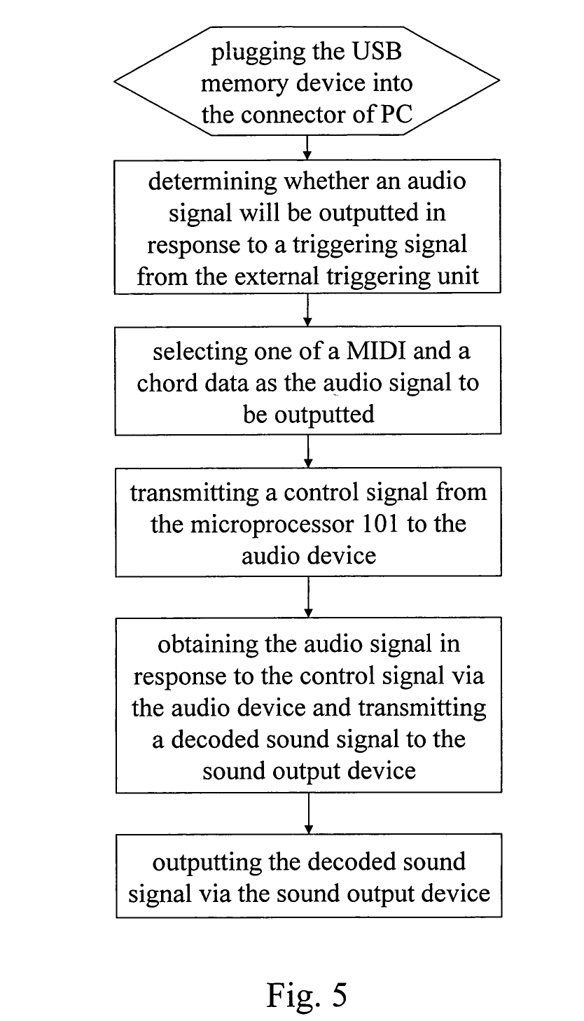

Please refer to FIG. 5. It further illustrates another preferred embodiment of a control method of the Universal Serial Bus (USB) memory system with an extra audio signal according to the present invention. Meanwhile, the USB memory system is disclosed as FIG. 3, wherein the USB memory system 100 includes a microprocessor 101; a storage unit 102 in communication with the microprocessor 101; an interface unit 103 in communication with the microprocessor 101 for connecting the USB memory system 100 to a host system 200, an audio device 104 in communication with the microprocessor 101, an external triggering unit 106 in communication with the microprocessor 101 for receiving a triggering signal to control the audio device 104, and a sound output device 105 in communication with the audio device 104. Accordingly, the control method of the USB memory system includes steps of a) connecting USB memory system 100 with the host system 200 via the interface unit 103; b) determining whether an audio signal will be outputted in response to a triggering signal from the external triggering unit 106; c) selecting one of a MIDI and a chord signal as the audio signal to be outputted d) transmitting a control signal from the microprocessor 101 to the audio device 104; e) obtaining the audio signal in response to the control signal via the audio device 104 and transmitting a resultant decoded sound signal to the sound output device 105; and f) outputting the decoded sound signal via the sound output device 105 in response to the control signal of the microprocessor 101 for informing about the current status of the USB memory device 100 or the trouble of the USB memory device 100.

In conclusion, the present invention provides a Universal Serial Bus (USB) memory system, which provides an extra audio signal in order to know if it is the trouble of the USB memory device cable, simplifies the performing process, and can rectify those drawbacks of the prior art and solve the above problems. Meanwhile the USB memory indicates the current status of itself via the sounds instead of the light from a LED indicator. No matter where the USB memory device is plugged in, even though the user can't see the USB memory device, the user is still able to know the current status of the USB memory device by means of checking the outputted sounds from the USB memory device of the present invention. Meanwhile the prior art fail to disclose that. Accordingly, the present invention possesses many outstanding characteristics, effectively improves upon the drawbacks associated with the prior art in practice and application, produces practical and reliable products, bears novelty, and adds to economical utility value. Therefore, the present invention exhibits a great industrial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A Universal Serial Bus (USB) memory system, comprising:
a microprocessor;
a storage unit in communication with said microprocessor;
an interface unit in communication with said microprocessor for connecting said USB memory system to a host system; and
an audio device in communication with said microprocessor for producing an audio signal in response to an instruction of said microprocessor, wherein said audio device is powered by said host system.

2. The USB memory system according to claim 1, wherein said storage unit comprises a flash memory, an Electrically Erasable Programmable Read Only Memory (EEPROM), a hard disk drive (HDD), and a memory card.

3. The USB memory system according to claim 1, wherein said interface unit comprises a serial peripheral interface (SPI), a host interface, a serial interface, a parallel interface, and an IIC interface.

4. The USB memory system according to claim 1, wherein said interface unit comprises IDE, ATA, SATA, and PCI-Express.

5. The USB memory system according to claim 1, wherein said host system is a personal computer.

6. The USB memory system according to claim 1, wherein said audio device is a MIDI output device.

7. The USB memory system according to claim 1, wherein said audio device further comprises a sound output device.

8. The USB memory system according to claim 7, wherein said sound output device is a sound speaker.

9. The USB memory system according to claim 1, wherein said host system further comprises a program for selecting one of a MIDI and a chord signal as said audio signal to be outputted in response to said instruction of said microprocessor.

10. The USB memory system according to claim 9, wherein said MIDI and said chord signal are downloaded from said host system and then decoded by said audio device.

11. The USB memory system according to claim 1, further comprising an external triggering unit in communication with said microprocessor for receiving a triggering signal to control said audio device.

12. The USB memory system according to claim 11, wherein said external triggering unit is one of a push button and an infrared ray receiver.

13. A control method of a USB memory system having a microprocessor, a storage unit in communication with said microprocessor, an interface unit in communication with said microprocessor, an audio device in communication with said microprocessor, and a sound output device in communication with said audio device, comprising the steps of:
a) automatically executing a program of a host system while said USB memory system is connected with said host system via said interface unit;
b) selecting one of a MIDI and a chord signal as an audio signal via said program;
c)transmitting said audio signal from said microprocessor to said audio device;
d) decoding said audio signal by said audio device and transmitting a resultant decoded sound signal to said sound output device; and
e) outputting said decoded sound signal in response to a control signal of said microprocessor via said sound output device.

14. The control method according to claim 13, wherein said host system is a personal computer.

15. The control method according to claim 13, wherein said audio device is a MIDI output device.

16. The control method according to claim 13, wherein said sound output device is a sound speaker.

17. A control method of a USB memory system having a microprocessor, a storage unit in communication with said microprocessor, an interface unit in communication with said microprocessor, an external triggering unit in communication with said microprocessor, an audio device in communication with said microprocessor, and a sound output device in communication with said audio device, comprising the steps of:
a) connecting USB memory system with said host system via said interface unit;
b) determining whether an audio signal will be outputted in response to a triggering signal from said external triggering unit;
c) selecting one of a MIDI and a chord signal as said audio signal to be outputted;
d)transmitting said audio signal to said audio device;
e) decoding said audio signal by said audio device and transmitting a resultant decoded sound signal to said sound output device; and
f) outputting said decoded sound signal in response to a control signal of said microprocessor via said sound output device.

18. The control method according to claim 17, wherein said external triggering unit is one of a push button and an infrared ray receiver.

19. The control method according to claim 17, wherein said audio signal is stored in said storage unit and transmitted from said storage unit to said audio device through said microprocessor.
